(19) United States
(12) Patent Application Publication
(10) Pub. No.: US 2026/0234805 A1
(43) Pub. Date: Aug. 13, 2026

(54) METHOD FOR MANUFACTURING Fe-Co-BASED COATED ALLOY SUBSTRATE, Fe-Co-BASED COATED ALLOY SUBSTRATE, AND LAMINATED CORE MEMBER

(71) Applicant: Proterial, Ltd., Tokyo (JP)

(72) Inventor: Yoshiyuki Fujihara, Tokyo (JP)

(73) Assignee: Proterial, Ltd., Tokyo (JP)

(21) Appl. No.: 19/105,325

(22) PCT Filed: Jun. 16, 2023
(86) PCT No.: PCT/JP2023/022394

§ 371 Date: Feb. 20, 2025

(30) Foreign Application Priority Data
Aug. 26, 2022 (JP) 2022-135094

(51) Int. Cl. C23C 18/12; C22C 30/00; H02K 1/02; H02K 1/06

(52) U.S. Cl. CPC C23C 18/1216; C22C 30/00; C23C 18/1241; C23C 18/125; H02K 1/02; H02K 1/06

(57) ABSTRACT

A method for manufacturing Fe—Co-based alloy substrate includes: a coating step of forming a liquid film by coating a magnesium hydroxide solution on a surface of an Fe—Co-based alloy substrate, and a heat treatment step of performing a heat treatment by setting a heating retention time such that the substrate after coating satisfies a temperature of 300° C. or higher and 480° C. or lower and a conditional expression (1): T×H/1000≤12.5 (where T is the heating retention time [min], and H is heating temperature [° C.]), thereby forming a magnesium oxide film having a thickness of 0.4 μm to 2.0 μm on the surface of the Fe—Co-based alloy substrate.

### TECHNICAL FIELD

The disclosure relates to a method for manufacturing Fe—Co-based coated alloy substrate, an Fe—Co-based coated alloy substrate, and a laminated core member.

### RELATED ART

In recent years, from the perspective of environmental protection, electrification in the automotive and aircraft industries has been actively considered, and there is an increasing demand for further high output, miniaturization, and high efficiency of the rotating machines to be installed. To achieve the performance of such rotating machines, it is necessary to improve the saturation magnetic flux density of a magnetic member used as a magnetic core material of the rotating machines and to improve the iron loss characteristics.

As a general magnetic member for rotating machines, an Fe-approximately 3 mass % Si-based alloy called non-oriented electrical steel sheet is used. However, an Fe—Co-based alloy called Permendur has been known for a long time as a magnetic member capable of obtaining an even higher saturation magnetic flux density.

Here, for magnetic members used in rotating machines, it is common to process the aforementioned non-oriented electrical steel sheet or Permendur substrate into a member shape and laminate them integrally. However, to achieve low iron loss, it is necessary to enhance the electrical insulation (hereinafter also simply referred to as insulation) between the laminated substrates. For example, Patent Document 1 discloses a laminated core member in which Fe—Co-based alloy substrates are laminated, and proposes forming a surface film of magnesium oxide, zirconium oxide, or aluminum oxide on the substrate surface as an insulating film.

### CITATION LIST

### Patent Literature

Patent Document 1: Japanese Patent Application Laid-Open Publication No. 2012-521649

### SUMMARY OF INVENTION

### Technical Problem

The laminated core member for rotating machines, which is composed of laminated Fe—Co-based alloy substrates coated with the surface film disclosed in the aforementioned Patent Document 1, excels in electrical insulation between the laminated substrates and is effective for enhancing the performance of rotating machines. On the other hand, in the case where the heat treatment conditions for forming the surface film are not optimized, due to embrittlement caused by the ordering of the Fe—Co-based alloy substrate, the workability when processing into a component shape using press-punching or the like, or the handling of the substrate may be impaired. Moreover, in the case where the thickness of the surface film is thin, there is a concern that high electrical insulation may not be obtained.

Thus, an objective of the disclosure is to provide a method for manufacturing Fe—Co-based coated alloy substrate, an Fe—Co-based coated alloy substrate, and a laminated core member that maintain the workability of the Fe—Co-based alloy substrate and possess high electrical insulation on the substrate surface.

### Solution to Problem

The inventors of the disclosure investigated the relationship between the heat treatment conditions when forming a surface film of magnesium oxide (hereinafter also written as MgO) on the surface of an Fe—Co-based alloy substrate and its workability, as well as the relationship between the surface film thickness and electrical insulation. As a result, it was found that by optimizing only the heat treatment conditions and the thickness of the MgO film, high electrical insulation can be obtained without significantly impairing the workability of the Fe—Co-based coated alloy substrate, leading to this disclosure.

In other words, one embodiment of the disclosure is a method for manufacturing Fe—Co-based coated alloy substrate characterized by including a step of forming a liquid film by coating a magnesium hydroxide solution on a surface of an Fe—Co-based alloy substrate, and a heat treatment step of performing a heat treatment by setting a heating retention time such that the substrate after coating satisfies a temperature of 300° C. or higher and 480° C. or lower and a following conditional expression (1), thereby forming a magnesium oxide film having a thickness of 0.4 μm to 2.0 μm on the surface of the Fe—Co-based alloy substrate:

$$Conditional expression ( 1 ) : T \times H / 1000 \leq 12.5$$

Here, T is the heating retention time [min], and His heating temperature [° C.].

Another embodiment of the disclosure is an Fe—Co-based coated alloy substrate in which a magnesium oxide film is formed on a surface of an Fe—Co-based alloy substrate, in which a total thickness of the magnesium oxide film is 0.4 μm to 2.0 μm, and when a test piece with a short side of 10 mm and a long side of 25 mm is taken from the coated alloy substrate and subjected to repeated 90-degree bending tests, a number of bending times until fracture occurs is 3 or more.

Another embodiment of the disclosure is a laminated core member in which the Fe—Co-based coated alloy substrate is laminated.

### Effects of Invention

According to the disclosure, it is possible to obtain an Fe—Co-based coated alloy substrate having high electrical insulation on the substrate surface while maintaining workability, and a high-performance laminated core member.

### BRIEF DESCRIPTION OF DRAWINGS

FIG. 1 is a schematic diagram for illustrating the 90-degree bending test in the present embodiment.

FIG. 2 is another schematic diagram for illustrating the 90-degree bending test in the present embodiment.

### DESCRIPTION OF THE EMBODIMENTS

First, in the disclosure, an Fe—Co-based alloy substrate is used as the magnetic member for the magnetic core material of rotating machines. The Fe—Co-based alloy substrate in this disclosure refers to a strip-shaped (coil) material or a rectangular thin plate (sheet). Moreover, the thickness of the Fe—Co-based alloy substrate in this disclosure may be, for example, 0.5 μm or less. A preferable thickness is 0.25 mm or less. Here, the Fe—Co-based alloy in this disclosure refers to an alloy material that contains 95% or more of Fe+Co in mass %, and contains 25 to 60% of Co. The preferable lower limit of Co content is 40%. This enables the achievement of a high magnetic flux density.

Next, the elements that may be included in the Fe—Co-based alloy of the disclosure will be described. To improve magnetic properties and cold workability, the Fe—Co-based alloy of the disclosure may contain one or more elements selected from V, Si, Mn, Al, Zr, B, Ni, Ta, Nb, W, Ti, Mo, and Cr, up to a total of 5.0% in mass %. For example, in the case of V, it is preferable to contain 1.0 to 3.0%. Moreover, examples of the impurity elements that are inevitably contained include, for example, C, S, P, and O, and it is preferable to set the upper limit of each of these to 0.1%.

In the manufacturing method of the disclosure, first, to form a film made of magnesium oxide (hereinafter also written as MgO) on the surface of the Fe—Co alloy substrate, a step of coating (coating step) a solution containing magnesium hydroxide (hereinafter also written as Mg(OH)₂) to form a liquid film. Moreover, the reason for selecting MgO for the surface film is that MgO excels in electrical insulation and thermal stability, and tends to have lower hardness compared to other oxide layers. Moreover, when magnetic annealing is performed to obtain the desired magnetic properties, the surface film is exposed to temperatures of around 850° C. in a hydrogen atmosphere, for example, but MgO is difficult to be reduced by hydrogen and also excels in resistance to welding between substrates.

In the disclosure, as a coating liquid for forming the aforementioned film composed of MgO, a Mg(OH)₂ solution (hereinafter also written as slurry) is used, in which Mg(OH)₂ powder, which is a precursor of MgO, is used as a solute and dispersed in a solvent. By using this slurry as the coating liquid, the slurry may be uniformly coated on the substrate surface with a stable film thickness. Mg(OH)₂ used as the solute in the slurry thermally decomposes to become MgO when heated, thus allowing easy formation of the MgO film. Here, magnesium carbonate (MgCO₃) may also be used as a precursor other than Mg(OH)₂. Moreover, as for the solvent of the slurry, water, amphoteric solvents such as alcohol, and organic solvents may be used. Methods for applying the slurry to the metal substrate include roll coating, which applies the slurry to the substrate with a roller, dip coating, which immerses the substrate in the slurry and then withdraws it, and screen printing. To improve the wettability between the substrate and the slurry, degreasing treatment of the substrate surface may be performed before coating the slurry, such as immersion in an alkaline solution or discharge treatment.

In the disclosure, after coating, a heat treatment step is carried out in which the substrate coated with the slurry is subjected to a heat treatment by setting a heating retention time so as to satisfy the temperature of 300° C. or higher and 480° C. or lower and the conditional expression “T×H/1000≤12.5 (here, T is the heating retention time [min], and H is the heating temperature [° C.])”, and a MgO film is formed on the substrate. In the case where the heat treatment step is performed with insufficient heat treatment temperature and heating retention time, the applied Mg(OH)₂ solution may not completely become an MgO film, and Mg(OH)₂ may remain overall or partially, raising concerns about decreased electrical insulation and reduced adhesion to the substrate. Conversely, with excessive heat treatment temperature and time, even if a complete MgO film is obtained, ordering of the Fe—Co alloy substrate may progress, and there is a concern that the workability of the Fe—Co alloy substrate will be impaired. Thus, in the disclosure, the substrate coated with the slurry is subjected to a heat treatment by setting a heating retention time so as to satisfy the temperature of 300° C. or higher and 480° C. or lower and the conditional expression “T×H/1000≤12.5 (here, T is the heating retention time [min], and H is the heating temperature [° C.])”. This enables the creation of an Fe—Co-based coated alloy substrate with excellent substrate workability and electrical insulation on the surface.

Even if the aforementioned conditional expression “T×H/1000≤12.5 (here, T is the heating retention time [min], and His the heating temperature [° C.])” is satisfied, in the case where the heat treatment temperature is below 300° C., no complete MgO film can be obtained, and Mg(OH)₂ remains overall or partially. Moreover, in the case where the heat treatment temperature exceeds 480° C., or even if the heat treatment temperature satisfies 300° C. or higher and 480° C. or lower, if the conditional expression “T×H/1000” exceeds 12.5, the ordering of the Fe—Co alloy substrate progresses, and there is a tendency that the workability of the Fe—Co alloy substrate is impaired. Moreover, the preferable lower limit of the heat treatment temperature is 350° C., and more preferably 400° C. Further, the preferable upper limit of the heat treatment temperature is 450° C. Furthermore, it is preferable to set the conditional expression within the range of “2.0≤T×H/1000≤12.5”, and more preferably within the range of “2.0≤T×H/1000≤5.0”. For example, the heat treatment time is set to 10 minutes in the case where the baking temperature is set to 450° C., T×H/1000 becomes 4.5, which falls within the range of the disclosure.

The atmosphere during heat treatment in the manufacturing method of the disclosure is preferably an inert gas atmosphere or a vacuum atmosphere. This is to prevent the deterioration of soft magnetic properties of the Fe—Co-based alloy substrate by excessive oxidation of the Fe—Co-based alloy substrate when baking is performed in air. This atmosphere may be appropriately selected according to the available equipment and desired properties. For example, in the case where productivity improvement is desired, it is preferable to use an inert gas atmosphere, which allows for improved productivity through continuous processing while passing the substrate through. In the case where it is difficult to introduce inert gas atmosphere equipment or in the case where cost reduction is desired, it is preferable to use a vacuum atmosphere. Examples of inert gas atmospheres include nitrogen gas atmosphere and Ar gas atmosphere.

In the disclosure, after coating (applying) a slurry on the surface of the Fe—Co alloy substrate, heat treatment is performed to form the MgO film, but a drying step to evaporate the solvent before the heat treatment may be provided. The drying step may be performed at a low temperature near the boiling point of the solvent, thus allowing for rapid drying of the slurry and suppressing liquid dripping that may cause unevenness in film thickness. Moreover, since the drying step may be performed at a low temperature, it has the advantage of being able to dry the liquid film into a dry film in air.

Here, the MgO film formed on the surface of the Fe—Co alloy substrate in the disclosure has a thickness of 0.4 μm to 2.0 μm. There is a correlation between the thickness of the MgO film and the electrical insulation of the surface, and by optimizing the film thickness along with the MgO formation of the surface film, the electrical insulation of the surface can be enhanced. In other words, in the case where the thickness of the MgO film formed on the substrate surface is below 0.4 μm, high electrical insulation cannot be obtained in the MgO layer (the sum of the MgO film formed on the upper substrate and the MgO film formed on the lower substrate) formed between the soft magnetic members of the laminated core member (hereinafter also referred to as a laminated core member for rotating machines) obtained by laminating Fe—Co-based coated alloy substrates. Moreover, in the case where the thickness of the MgO film exceeds 2.0 μm, high electrical insulation can be obtained, but there is concern that the workability may be impaired in the case where the substrate is press-punched into a component shape or the like, and the productivity of the Fe—Co coated alloy substrate may decrease. The preferable lower limit of the MgO film thickness is 0.5 μm, and the preferable upper limit of the MgO film thickness is 1.0 μm. Moreover, the “thickness of the MgO film formed on the surface of the substrate” in the disclosure indicates the total thickness, which is the sum of the thicknesses of the MgO films formed on both sides of the substrate. Specifically, for example, cases where an MgO film of 0.2 μm is formed on the surface of the substrate and 0.2 μm on the back surface, or where an MgO film of 0.4 μm is formed on the surface of the substrate and no MgO film is formed on the back surface, are also included in the scope of the disclosure. Preferably, the MgO film is formed on both sides of the substrate. Moreover, when forming the MgO film on both sides of the substrate, the thickness of the MgO film formed on one side is 0.2 mm or more. Further, it is preferable that the film thickness is controlled by the thickness with effective number up second decimal places, and more preferable that the thickness of the MgO film formed on one side is 0.40 μm or more. When the thickness of the MgO film formed on one side is 0.40 μm or more, and the total thickness of both sides is 0.60 μm or more, excellent sheet resistance (electrical insulation) of 9.0×10⁶ (Ω/□) or more can be obtained.

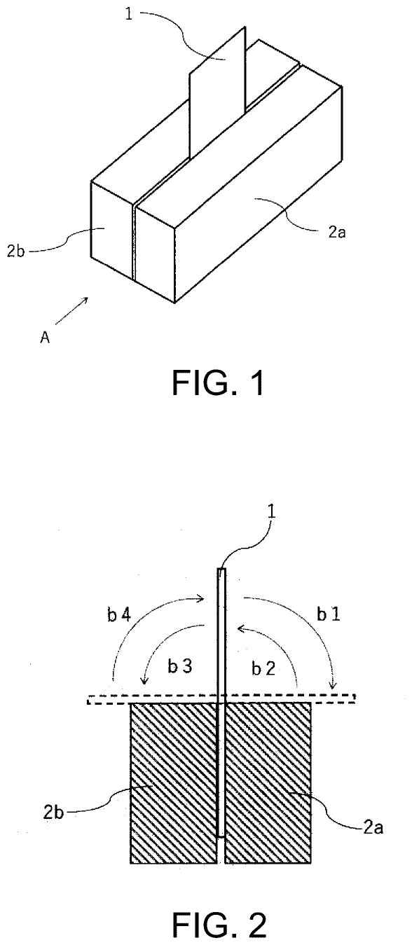

Moreover, the Fe—Co-based coated alloy substrate obtained by the manufacturing method of the disclosure shows good workability with a number of bending times of 3 or more until fracture occurs in a 90-degree bending test, as the ordering of the Fe—Co alloy substrate can be suppressed. FIG. 1 and FIG. 2 show schematic diagrams of the 90-degree bending test apparatus of this embodiment. FIG. 2 is a schematic diagram viewed from direction A in FIG. 1. In the 90-degree bending test of this embodiment, a test piece 1 with a short side of 10 mm and a long side of 25 mm is sandwiched perpendicular to the long side direction (rolling direction) with clamping jigs 2a and 2b having an edge chamfer width of 0.1 mm or less, and repeated 90-degree bending is performed to measure the number of bending times every 90 degrees until the test piece fractures. Moreover, the number of bending times specified in the disclosure is an average value, and specifically, two test pieces may be taken and measured, and the average of the obtained results may be used. Moreover, the number of bending times is counted when the test piece is bent and when the bent test piece is returned. For example, the bending test is performed in the order of b1 (bend)→b2 (return)→b3 (bend in the opposite direction to b1)→b4 (return) as shown in FIG. 2, and when the test piece fractures in the middle of b4, the number of bending times is counted as 4.

The laminated core member for rotating machines using the aforementioned Fe—Co-based coated alloy substrate can achieve high performance of rotating machines due to the high magnetic flux density of the substrate and low iron loss resulting from high electrical insulation of the surface. Moreover, in actual manufacturing of laminated core member for rotating machines, multiple sheets of the substrate of the disclosure are laminated. At this time, in the case where the MgO layer is formed on both sides (front and back) of the substrate, the thickness during lamination becomes the sum of the thickness of the MgO film on the back side formed on the upper substrate and the thickness of the MgO film on the front side formed on the lower substrate. For example, if substrates having MgO films with a thickness of 0.2 μm on both sides are laminated, the thickness of the MgO layer formed between the substrates becomes 0.4 μm.

### INVENTION EXAMPLES

### Invention Example 1

As an alloy substrate, a cold-rolled material (alloy substrate sheet) of a Fe—Co-based alloy shown in Table 1 was prepared. Subsequently, after performing degreasing treatment with an alkaline solution, water washing, and hot air drying on the prepared substrate, a coating step was performed to form a liquid film of slurry on both surfaces of the substrate by dip coating, in which the substrate was immersed in a slurry where Mg(OH)₂ particles as a solute were dispersed in water as a solvent, and then withdrawn.

The withdrawal speed of the dip coating was fixed at 1.2 mm/s. The substrate on which the liquid film was formed was treated in air at a temperature of 110° C. for a retention time of 5 min, and a drying step was performed to temporarily dry the liquid film. After drying the liquid film, the substrate was further subject to heat treatment, as a heat treatment step, in a nitrogen gas atmosphere at a heat treatment temperature of 400 to 600° C. for a retention time of 5 to 60 min, to obtain a Fe—Co-based coated alloy substrate having an MgO film with a thickness of 0.75 μm on both surfaces of the substrate.

The MgO formation of the surface film after heat treatment was determined by the presence or absence of diffraction peaks of the (101) plane of Mg(OH)₂ and the (200) plane of MgO using X-ray diffraction method (CoKα source), and the quality of substrate workability was determined by a 90-degree bending test method. Here, in the 90-degree bending test, a test piece with a short side of 10 mm and a long side of 25 mm was sandwiched with a metal clamping jig (chamfer width of 0.1 mm or less) at a right angle to the long side direction (rolling direction), repeated 90-degree bending was performed, and the number of bending times of every 90-degree bend until the test piece fractured was evaluated. Moreover, the 90-degree bending test was conducted by taking two test pieces for each heat treatment condition, and heat treatment conditions showing an average number of bending times of 3 or more were judged as satisfactory. The results are shown in Table 2 (the value of “Temperature×Time” in Table 2 indicates T×H/1000).

TABLE 1

| Plate | | | | | | |
|---|---|---|---|---|---|---|
| thickness | Component (mass %) | | | | | |
| (mm) | C | Si | Mn | Co | V | Residue |
| 0.1 | 0.001 | 0.04 | 0.05 | 48.9 | 1.89 | Fe and inevitable |
| | | | | | | impurity |

TABLE 2

| | Heat treatment conditions | | | | | Bending test | |
|---|---|---|---|---|---|---|---|
| | | | Temp. × | X-ray diffraction | | Number | |
| | | | Time/ | peaks | | of bending | |
| | Temperature | Time | 1000 | Mg(OH)₂ | MgO | times | |
| No. | (° C.) | (min) | (—) | (101) | (200) | (times) | Remark |
| 1 | 110 | 5 | 1.1 | Yes | No | 4.5 | Comparative example |
| 2 | 400 | 5 | 2.0 | No | Yes | 5 | Example of the disclosure |
| 3 | | 10 | 4.0 | No | Yes | 5 | Example of the disclosure |
| 4 | | 30 | 12.0 | No | Yes | 3 | Example of the disclosure |
| 5 | | 60 | 24.0 | No | Yes | 2.5 | Comparative example |
| 6 | 450 | 5 | 2.3 | No | Yes | 4.5 | Example of the disclosure |
| 7 | | 10 | 4.5 | No | Yes | 3 | Example of the disclosure |
| 8 | | 30 | 13.5 | No | Yes | 1 | Comparative example |
| 9 | | 60 | 27.0 | No | Yes | 1 | Comparative example |
| 10 | 500 | 5 | 2.5 | No | Yes | 2 | Comparative example |
| 11 | | 10 | 5.0 | No | Yes | 1 | Comparative example |
| 12 | | 30 | 15.0 | No | Yes | 1 | Comparative example |
| 13 | | 60 | 30.0 | No | Yes | 1 | Comparative example |
| 14 | 600 | 5 | 3.0 | No | Yes | 1 | Comparative example |
| 15 | | 10 | 6.0 | No | Yes | 1 | Comparative example |
| 16 | | 30 | 18.0 | No | Yes | 1.5 | Comparative example |
| 17 | | 60 | 36.0 | No | Yes | 2 | Comparative example |

From the results in Table 2, in Example No. 2 to 4, 6, and 7, which are the Fe—Co-based coated alloy substrates of the disclosure, by the disappearance of the diffraction peak at the (101) plane of Mg(OH)₂ and the detection of the diffraction peak at the (200) plane of MgO, it was confirmed that the surface film was completely converted into MgO, as evidenced, and it was confirmed that the number of 90-degree bending times is also 3 to 5, and that good workability of the Fe—Co alloy substrate is obtained. Moreover, it may be known that although condition No. 1, which falls outside the specifications of the disclosure and serves as a comparative example, leaves the liquid film after dip coating in a dried state, the number of bending times was 4.5, indicating good workability; on the other hand, the diffraction peak at the (101) plane of Mg(OH)₂ remains (the diffraction peak at the (200) plane of MgO is not detected), indicating that the heat treatment condition is insufficient. Moreover, in conditions No. 5 and 8 to 17, which serve as comparative examples, the disappearance of the diffraction peak at the (101) plane of Mg(OH)₂ and the detection of the diffraction peak at the (200) plane of MgO were confirmed, but the number of 90-degree bending times was 1 to 2.5, and a significant decrease in workability was observed, which is presumed to be influenced by the ordering of the Fe—Co alloy substrate, and these were unsuitable heat treatment conditions.

### Invention Example 2

The alloy substrate sheets of Fe—Co-based alloy as shown in Table 3 were prepared, and similar to Invention Example 1, the prepared substrates were subjected to degreasing treatment with an alkaline solution, water washing, and hot air drying. Subsequently, a liquid film of slurry was formed on both surfaces of the substrate by dip coating, which involved immersing the substrate in a slurry where Mg(OH)₂ particles as a solute were dispersed in water as a solvent, and then withdrawing it.

The withdrawal speed of the dip coating was adjusted within the range of 0.02 to 1.20 mm/s such that the thickness of the liquid film to be coated would vary accordingly. After drying the liquid film, the substrate was further subjected to heat treatment in a nitrogen gas atmosphere at a heat treatment temperature of 400° C. or higher (maximum temperature reached was 417° C.) for a retention time of approximately 10 min. The value of the conditional expression (1) is approximately 4.1.

The thickness of the surface film (MgO) after heat treatment was measured using a transmission electron microscope (TEM) after surface processing of a film test piece for thickness measurement from a cross-section in the thickness direction of the substrate perpendicular to the rolling direction of the substrate using a focused ion beam device (FIB-SEM). Moreover, the electrical insulation of the surface film (MgO) after heat treatment was evaluated by measuring the sheet resistance (surface resistivity) using the four-terminal method with a resistivity measuring device. The results are shown in Table 4. Here, the film thickness shown in Table 4 indicates the thickness formed on one side of the substrate. In reality, since the MgO film is formed on both surfaces of the substrate, a total film thickness, which is the sum of the film thickness on the surface side and the film thickness of the back side of the substrate, is approximately twice the thickness indicated in Table 4.

TABLE 3

| Plate | | | | | | |
|---|---|---|---|---|---|---|
| thickness | Component (mass %) | | | | | |
| (mm) | C | Si | Mn | Co | V | Residue |
| 0.2 | 0.002 | 0.03 | 0.03 | 49.0 | 1.90 | Fe and inevitable |
| | | | | | | impurity |

From the results in Table 4, it was found that the conditions of Example No. 24 to 26 of the disclosure, which have a film thickness of 0.40 μm or more on one side, possess high sheet resistance (electrical insulation). Moreover, in all of No. 24 to 26, the thickness of the MgO film formed on one side was 0.40 μm or more, and a total film thickness of the front side and back side was 0.60 μm or more. In contrast, the Example No. 22 and 23 of the disclosure, with a film thickness of below 0.40 μm on one side, showed a slight improvement in electrical insulation compared to No. 18, which is a substrate without an MgO film on the surface. Moreover, the comparative examples, conditions No. 19 to 21, did not show a significant difference in sheet resistance compared to No. 18, which is a substrate without an MgO film on the surface, and did not exhibit high electrical insulation.

Moreover, in this embodiment, each sample was a single coated alloy substrate sheet, but when actually used as a laminated core member for rotating machines, a step of laminating multiple alloy substrate sheets is carried out. Since the MgO layer existing between these laminated substrates becomes the combined thickness of the MgO layer formed on the upper substrate and the MgO layer formed on the lower substrate, if alloy substrate sheets with MgO films formed on both sides with a film thickness of 0.2 μm or more on one side (total film thickness of 0.4 μm or more), as in the conditions of Example No. 22 and 23 of the disclosure, are used for lamination, the combined thickness of the MgO layer existing between the substrates during lamination becomes 0.40 μm or more, and good electrical insulation can be expected. Moreover, with the film thickness of the conditions of Example No. 24 to 26 of the disclosure, high sheet resistance (electrical insulation) can be obtained even if the MgO film is formed only on one side.

As described above, the Fe—Co-based coated alloy substrate obtained by the manufacturing method of the disclosure possesses good workability and high electrical insulation, and can therefore contribute to improving the manufacturability of laminated core members and enhancing the performance of rotating machines.

TABLE 4

| | Withdrawal | Film thickness | Sheet | |
|---|---|---|---|---|
| | speed | (one side) | resistance | |
| No. | (mm/s) | (μm) | (Ω/□) | Remark |
| 18 | — | 0.00 | 1.0 × 10⁻³ | Comparative |
| | | | | example |
| 19 | 0.020 | 0.08 | 1.2 × 10⁻³ | Comparative |
| | | | | example |
| 20 | 0.035 | 0.12 | 1.2 × 10⁻³ | Comparative |
| | | | | example |
| 21 | 0.050 | 0.16 | 1.2 × 10⁻³ | Comparative |
| | | | | example |
| 22 | 0.100 | 0.25 | 1.4 × 10⁻³ | Example of |
| | | | | the disclosure |
| 23 | 0.200 | 0.39 | 1.4 × 10⁻³ | Example of |
| | | | | the disclosure |
| 24 | 0.400 | 0.43 | 9.0 × 10⁶ or more | Example of |
| | | | | the disclosure |
| 25 | 0.700 | 0.56 | 9.0 × 10⁶ or more | Example of |
| | | | | the disclosure |
| 26 | 1.200 | 0.75 | 9.0 × 10⁶ or more | Example of |
| | | | | the disclosure |

### REFERENCE SIGNS LIST

1 Coated substrate
2a, 2b Clamping jig

1. A method for manufacturing Fe—Co-based coated alloy substrate, comprising:
a coating step of forming a liquid film by coating a magnesium hydroxide solution on a surface of an Fe—Co-based alloy substrate, and
a heat treatment step of performing a heat treatment by setting a heating retention time such that the substrate after coating satisfies a temperature of 300° C. or higher and 480° C. or lower and a following conditional expression (1), thereby forming a magnesium oxide film having a thickness of 0.4 μm to 2.0 μm on the surface of the Fe—Co-based alloy substrate:
T×H/1000≤12.5 conditional expression (1)
wherein T is the heating retention time [min], and H is heating temperature [° C.].

2. An Fe—Co-based coated alloy substrate in which a magnesium oxide film is formed on a surface of an Fe—Co-based alloy substrate, wherein
a thickness of the magnesium oxide film is 0.4 μm to 2.0 μm, and
when a test piece with a short side of 10 mm and a long side of 25 mm is taken from the Fe—Co-based coated alloy substrate and subjected to repeated 90-degree bending tests, a number of bending times until fracture occurs is 3 or more.

3. A laminated core member, wherein the Fe—Co-based coated alloy substrate according to claim 2 is laminated.
